(19) United States
(12) Patent Application Publication
(10) Pub. No.: US 2009/0314883 A1
(43) Pub. Date: Dec. 24, 2009

(54) UAV LAUNCH AND RECOVERY SYSTEM

(76) Inventors: Paul E. Arlton, West Lafayette, IN (US); David J. Arlton, West Lafayette, IN (US)

Correspondence Address: BARNES & THORNBURG LLP, 11 SOUTH MERIDIAN, INDIANAPOLIS, IN, 46204, US

(21) Appl. No.: 12/119,428

(22) Filed: May 12, 2008

Related U.S. Application Data
(60) Provisional application No. 60/917,264, filed on May 10, 2007.

(51) Int. Cl. B64F 1/04; B25J 9/00

(52) U.S. Cl. 244/63; 700/245

(57) ABSTRACT

An unmanned aerial vehicle (UAV) is launched and recovered using a UAV management system. The UAV is stored in a magazine and moved from the magazine during a launch operation and to the magazine during a recovery operation.

This application claims priority under 35 U.S.C. § 119(e) to U.S. Provisional Application Ser. No. 60/917,264, filed Saturday, May 10, 2007, which is expressly incorporated by reference herein.

### BACKGROUND

The present disclosure relates to aerial vehicles and particularly to unmanned aerial vehicles (UAVs). More particularly, the present disclosure relates to a system and methods for launching a UAV and for recovering a UAV.

### SUMMARY

According to the present disclosure, a system for a launching operation of an unmanned aerial vehicle (UAV) and a recovery operation of an unmanned aerial vehicle (UAV) comprises a magazine configured to store a UAV and a robotic assembly configured to interact with the magazine, to connect to the UAV and position the UAV relative to the magazine during the launching operation and the recovery operation. In an illustrative embodiment, the robotic assembly includes a multi-axis robotic arm and a controller in communication with and configured to control the multi-axis robotic arm to position the UAV relative to the magazine during the launching operation and the recovery operation. In another illustrative embodiment, the system comprises a power supply configured to charge a battery onboard the UAV.

In a further illustrative embodiment, the system comprises a plurality of UAVs and a method of launching a UAV and a method of recovering a UAV.

Additional features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompany figures in which:

FIG. 1 is a side elevation view of a system for launching and recovery an unmanned aerial vehicle (UAV), in accordance with the present disclosure, showing the UAV prepared for launching, and further showing a robotic assembly having a multi-axis robotic arm supporting the UAV, the robotic assembly being located adjacent a magazine configured to store the UAV before the launching operation and after the recovery operation;

FIG. 2 is a perspective view of the system of FIG. 1, showing (from left to right) the multi-axis robotic arm in a stowed position and the robotic assembly coupled to a magazine, and further showing a plurality of UAVs stored in the magazine;

FIGS. 3-6 illustrate a sequence of launching a UAV, in accordance with the present disclosure;

FIG. 3 is a perspective view of the system of FIG. 2 showing a magazine cover moved to an opened position and the multi-axis robotic arm extracting a pre-selected UAV from the magazine in preparation for a launching operation;

FIG. 4 is a side elevation view of the system of FIG. 3 showing the multi-axis robotic arm having fully extracted the UAV from the magazine;

FIG. 5 is a perspective view of the system of FIG. 4 showing the UAV being positioned in a predetermined pitch attitude in preparation for launch;

FIG. 6 is a side elevation view similar to FIG. 5 showing the UAV having been launched;

FIGS. 7-11 illustrate a sequence of recovering a UAV in accordance with the present disclosure;

FIG. 7 is a perspective view of the system of FIG. 2 showing a UAV approaching the system for a recovery operation;

FIG. 8 is an elevation view of the system of FIG. 7 showing a UAV having been “captured” by the multi-axis robotic arm and further showing a recovery window (in phantom), the recovery window corresponding to movement limits of the multi-axis robotic arm;

FIG. 9 is a forward perspective, view similar to FIG. 8, showing the UAV being maneuvered in a roll attitude in preparation for being stored in the magazine after having been captured by the multi-axis robotic arm;

FIG. 10 is a perspective view similar to FIG. 5, showing the captured UAV being rolled toward an inverted position in preparation for storage in the magazine;

FIG. 11 is a side elevation view, similar to FIG. 10, showing the UAV in an inverted position and the multi-axis robotic arm moving the UAV into the magazine for storage, as suggested by the downward facing bold arrow;

FIG. 12 is a perspective view of a portion of a multi-axis wrist of the multi-axis robotic arm, showing the multi-axis wrist coupled to an upper end of the multi-axis robotic arm, and the multi-axis wrist including a gripper configured to cooperate with a capture device on the UAV to couple the multi-axis robotic arm to the UAV;

FIG. 13 is a perspective view of a another embodiment of a system for launching and recovering an Unmanned Aerial Vehicle (UAV), in accordance with the present disclosure, the system comprising a Mobile Base Unit (MBU) including a magazine configured to store a plurality of UAVs and further including two multi-axis robotic arms and a power supply for charging the UAVs in the magazine; and

FIG. 14 is a perspective view of the Mobile Base Unit (MBU) of FIG. 13 showing a 3-dimensional recovery box defined by XYZ servo axes defining travel limits of the multi-axis robotic arm.

### DETAILED DESCRIPTION

The present disclosure relates to a system 10 for a launching operation of an unmanned aerial vehicle (UAV) 12 and a recovery operation of a UAV 12. The UAVs 12 may be launched and recovered from a variety of stationary and mobile launch and recovery platforms such as, for example, vehicle 14 configured as a high-mobility multipurpose wheeled vehicle (HMMWV). However, it is within the scope of the present disclosure to utilize other platforms including, for example, trucks, tracked vehicles, boats, unmanned ground vehicles, stationary platforms such as, for example, buildings, ship docks, radio towers, oil tanks, pipe lines and perimeter fences, or other such platforms suitable for launching and recovering UAVs 12.

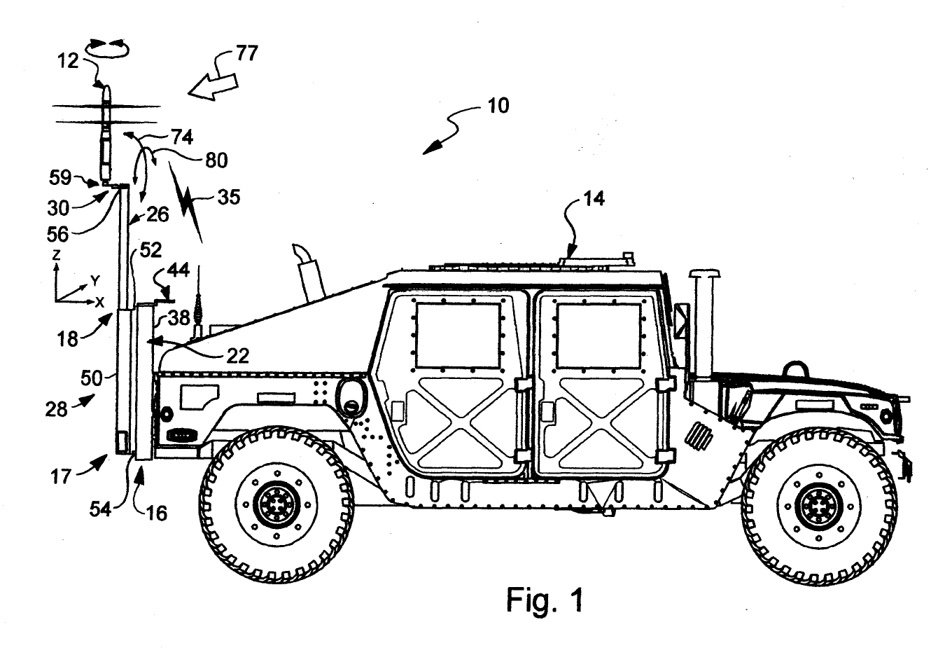

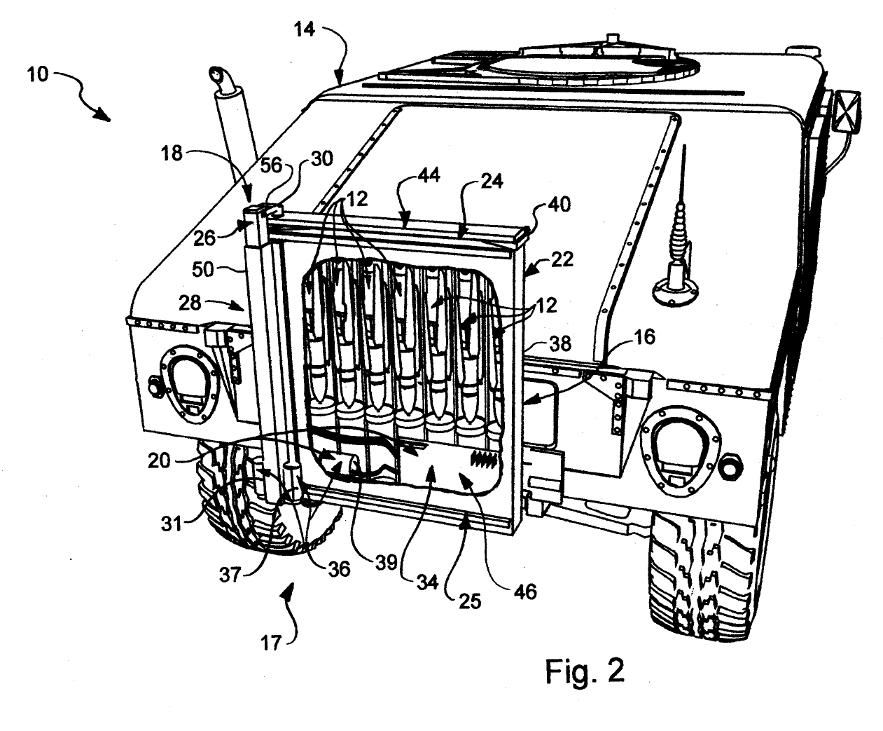

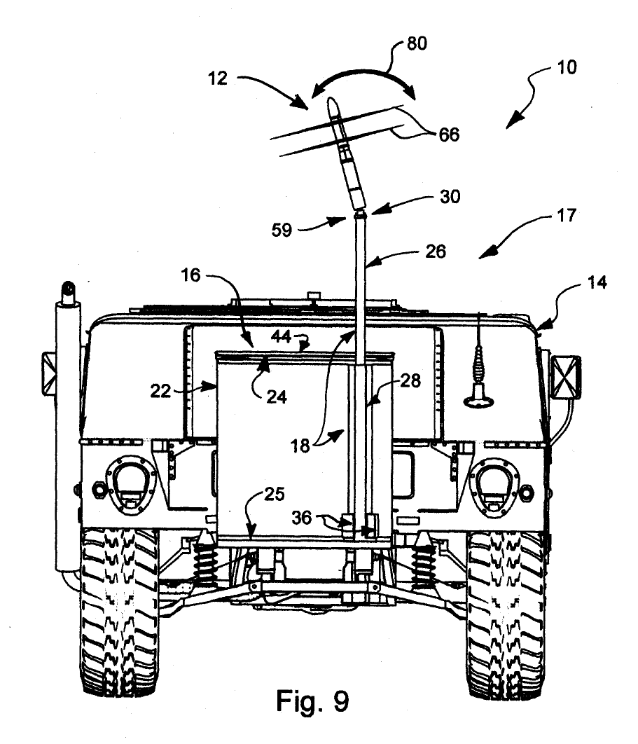

System 10 includes a base 16 configured to be mounted on vehicle 14 and a robotic assembly 17 located adjacent to base 16. Robotic assembly 17 includes a multi-axis robotic arm 18 and a controller 20 configured to communicate with the multi-axis robotic arm 18 for selective operation of multi-axis robotic arm 18, as suggested by the different positions and movements of multi-axis robotic arm in FIGS. 1-11. Base 16 includes a magazine 22 including, for example, storage tubes 42 configured to store UAVs 12 therein and a pair of spaced-apart parallel rails 24, 25, as shown in FIG. 2, coupled to an upper and a lower portion of magazine 22, respectively. In illustrative embodiments of system 10, base 16 is coupled to vehicle 14 by, for example, fasteners, welding, or other suitable couplers.

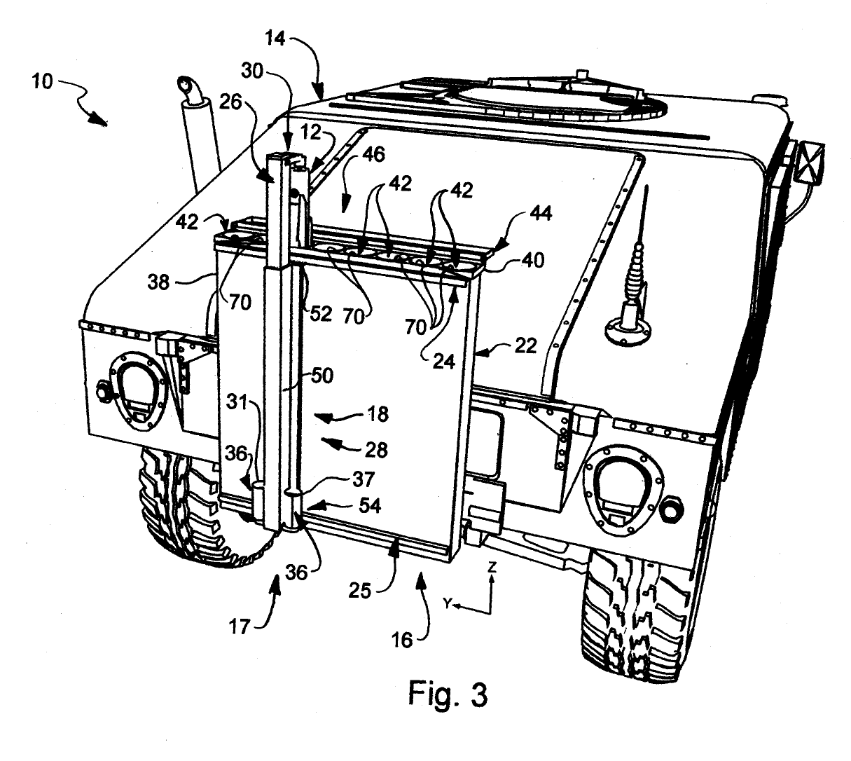

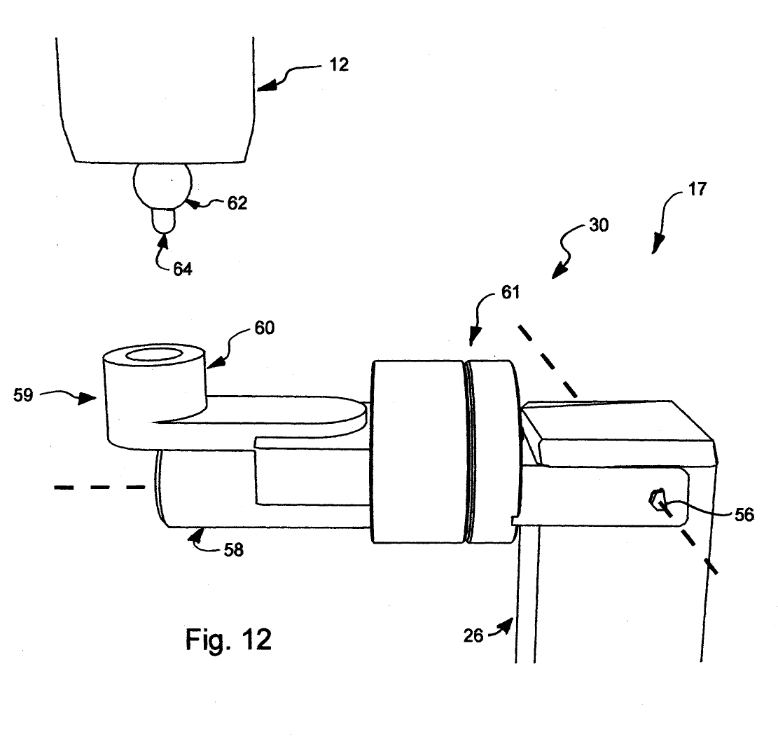

Multi-axis robotic arm 18 is configured to be manipulated in six (6) degrees of freedom or motion directions. Such motion directions include linear directions X, Y, and Z and rotary directions roll, pitch and yaw, as shown by the directional icons and arrows in FIG. 1. Multi-axis robotic arm 18 includes an extension rod 26, a carriage 28 movable horizontally along a Y-axis and arranged to receive extension rod 26 for telescoping movement relative thereto as suggested in FIG. 3. Multi-axis robotic arm 18 also includes a multi-axis wrist 30 and a gripper 59, configured, for example, as a latch collect 60, and coupled to an upper end of extension rod 26, as shown in FIG. 12. Telescoping movement of extension rod 26 is actuated by a ball-screw assembly (not shown) driven by Z-axis servo 37, as shown in FIG. 3. Multi-axis robotic arm 18 is arranged to connect to and extract a selected UAV 12 from magazine 22, position the selected UAV 12 in a proper attitude for launch, capture the selected UAV 12 during a post-mission recovery, and return the selected UAV 12 to magazine 22 for storage therein. Multi-axis robotic arm 18 is coupled to rails 24, 25 for slidable horizontal movement relative to base 16 and driven by Y-axis servo 39 located near a bottom portion of magazine 22, as shown in FIG. 2.

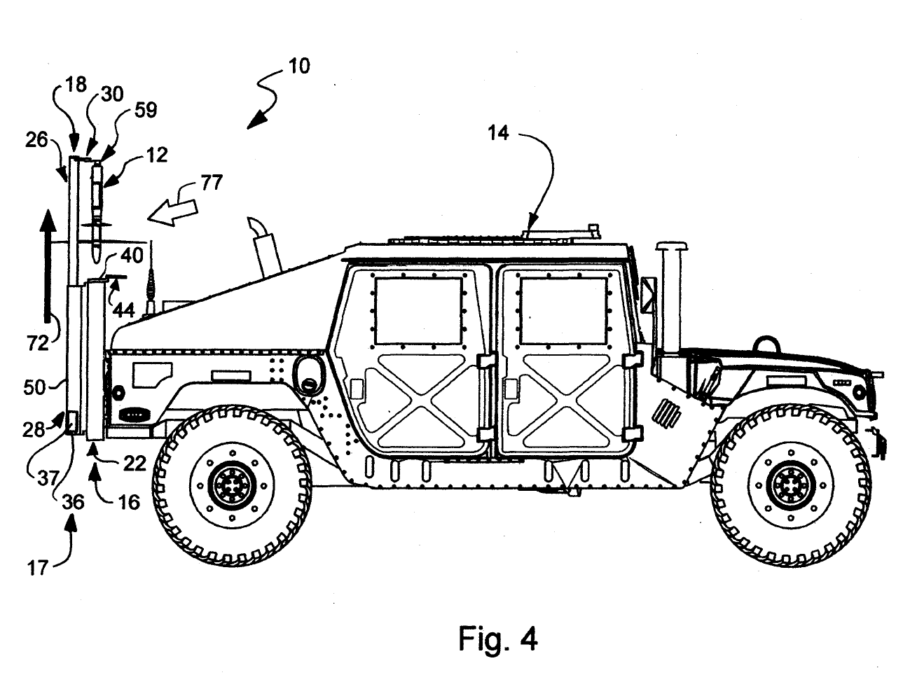

Controller 20 includes a computer 34 and servos 36. Controller 20 is configured to move and position multi-axis robotic arm 18 to extract UAV 12 from or return UAV 12 to magazine 22, as suggested in FIGS. 4, 5, 10 and 11. Computer 34 may be housed, for example, in a lower portion of magazine 22 or located remotely (not shown). In an illustrative embodiment, three to six servos 36 may be provided for controller 20. A pair of servos 36 for Z-axis motion and pitch motion are coupled to horizontal carriage 28 and a third servo 36 for Y-axis motion is positioned to lie in magazine 22 adjacent to computer 34.

Horizontal carriage 28 includes a rod-receiving sleeve 50 configured to receive extension rod 26 therein and upper and lower connectors 52, 54 coupled to rails 24 and 25, respectively. Horizontal carriage 28 is arranged to provide horizontal movement of multi-axis robotic arm 18 relative to magazine 22 along rails 24 and 25.

Multi-axis wrist 30 includes a pitch connector 56, a roll-axis servo 58, and gripper 59 configured as latch collet 60. Pitch connector 56 is coupled to an upper portion of extension rod 26 for pivotable movement thereto and provides means for adjusting a pitch attitude of multi-axis wrist 30 during launching and recovery operations. Pitch motions of multi-axis wrist 30 are driven by pitch servo 31 (see FIG. 2) through a torque rod assembly (not shown) inside extension rod 26. Roll-axis servo 58 is coupled to a roll connector 61 and is configured to provide means for adjusting a roll attitude of multi-axis wrist 30 during launching and recovery operations.

UAV 12 is configurable and adaptable for use with the structure disclosed in U.S. Patent Application Publication No. 2006/0011777, the disclosure of which is hereby incorporated by reference herein. In an illustrative embodiment, UAV 12 includes a capture device, configured, for example, as a ball stud 62 and a light-emitting diode (LED) 64, as shown in FIG. 12. Ball stud 62 extends from a bottom portion of UAV 12. Ball stud 62 is configured to engage latch collet 60 and rigidly couple UAV 12 to multi-axis wrist 30 of multi-axis robotic arm 18 during both launching and recovery operations.

During launching and recovery operations, for example, from mobile platforms such as vehicle 14, the direction of airflow over UAV 12 is determined, at least in part, by the ground speed of vehicle 14 and local atmospheric wind conditions. This airflow is defined herein as the relative wind 77, as suggested in FIG. 4. While it is generally desirable to launch a UAV 12 into the relative wind 77, the direction and intensity of relative wind 77 may be constantly changing.

Ground vehicle 14 may, for example, be traveling in a convoy of similar vehicles at, for example, 30 to 60 miles per hour. Air passing over the top and sides of vehicle 14 may create a turbulent airflow around vehicle 14 in the direction of travel of vehicle 14. As vehicle 14 passes other vehicles or buildings the direction of the local side winds may change abruptly thereby affecting the relative wind 77. An advantageous feature, for example, of the current disclosure is that a UAV may be positioned to perform a launching operation directly into the relative wind 77 under most circumstances.

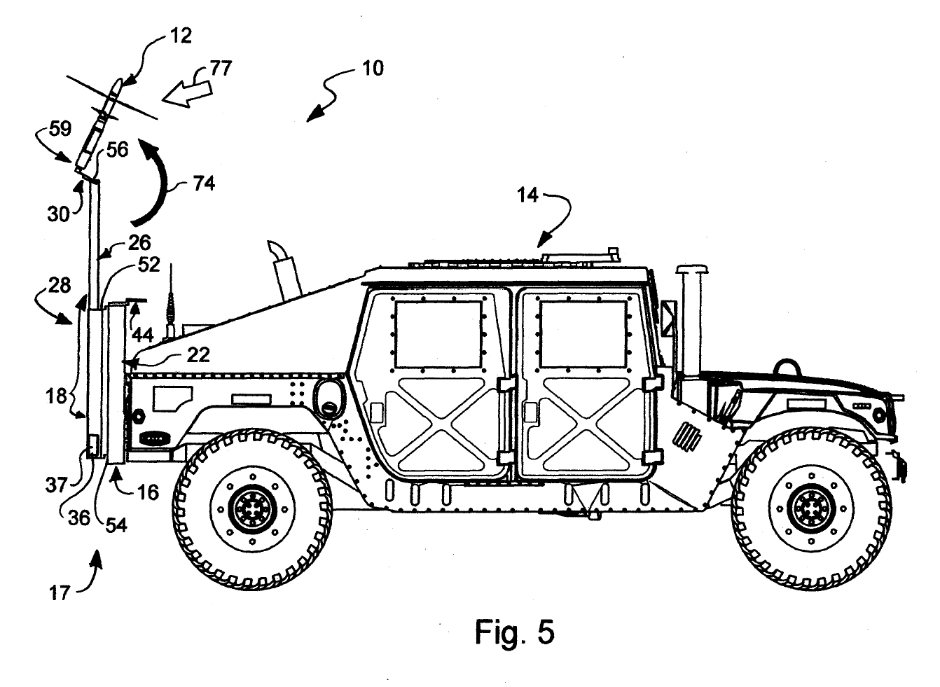

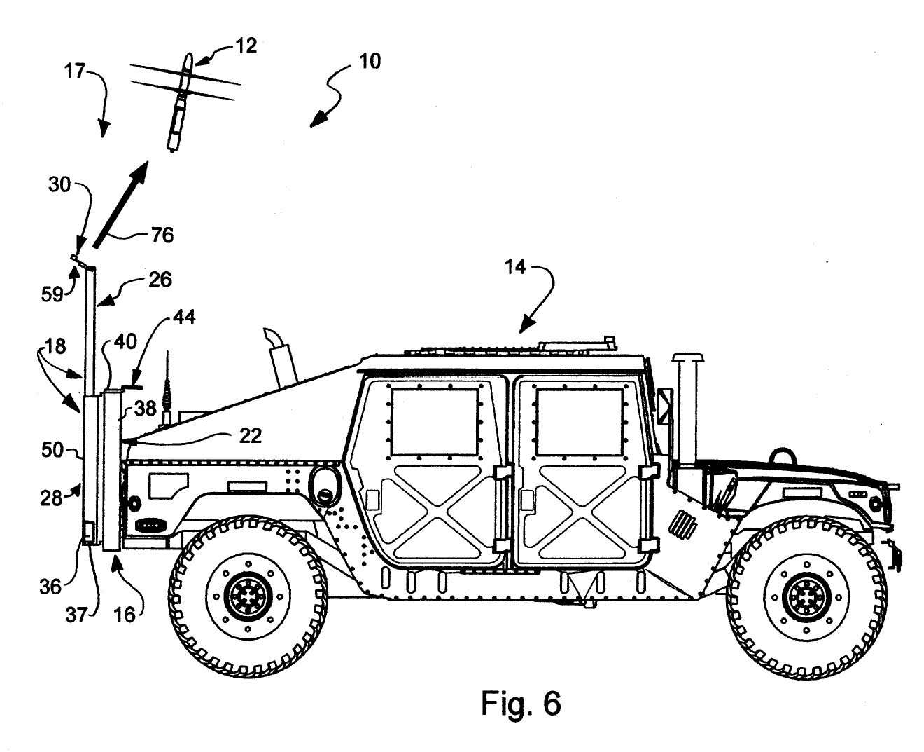

In a UAV 12 launch sequence, multi-axis robotic arm 18 extracts one of the UAVs 12 from magazine 22 in a direction 72 as shown in FIG. 4. Controller 20 then causes multi-axis robotic arm 18 to position UAV 12 in a proper attitude, as suggested by direction 74 in FIG. 5, for launch based upon input from computer 34. Computer 34 determines a desirable launch attitude for UAV 12 based upon factors such as, for example, the weight and lifting power of UAV 12 and the relative wind 77. Computer 34 then causes multi-axis wrist 30 to provide a suitable roll and pitch attitude for the launch of UAV 12 and initiates a UAV launch sequence wherein rotor blades of rotor system 66 begin turning to generate aerodynamic lift. When sufficient lift is available for UAV 12 to fly under its own power, computer 34 causes latch collet 60 to open and UAV 12 is released in a direction 76, for example, which is tilted into relative wind 77, as suggested in FIGS. 5 and 6.

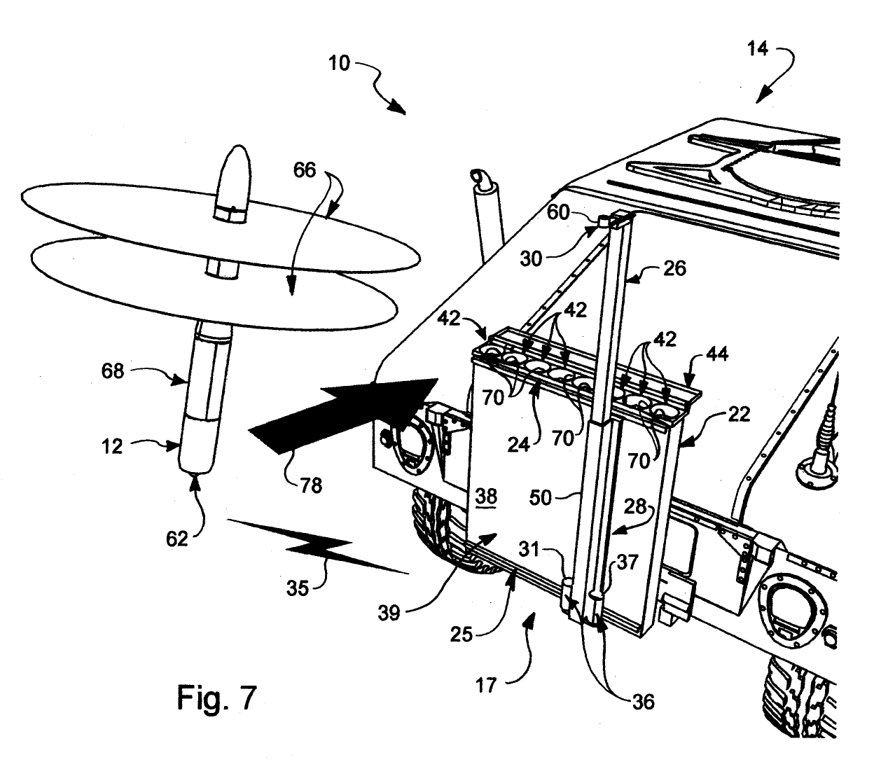

In a UAV 12 recovery sequence, controller 20 is configured to move and position multi-axis robotic arm 18 to capture UAV 12 in flight, as suggested in FIGS. 7-11. Controller 20, including computer 34, is configured to establish high-speed bi-directional communications 35 with UAV 12 to coordinate launching and recovery operations. Controller 20 is configured to sense and compute vehicle 14 motion, atmospheric conditions, and relative motion of UAV 12 to provide flight instructions to UAV 12 and movement instructions to multi-axis robotic arm 18 to coordinate launching and recovery operations.

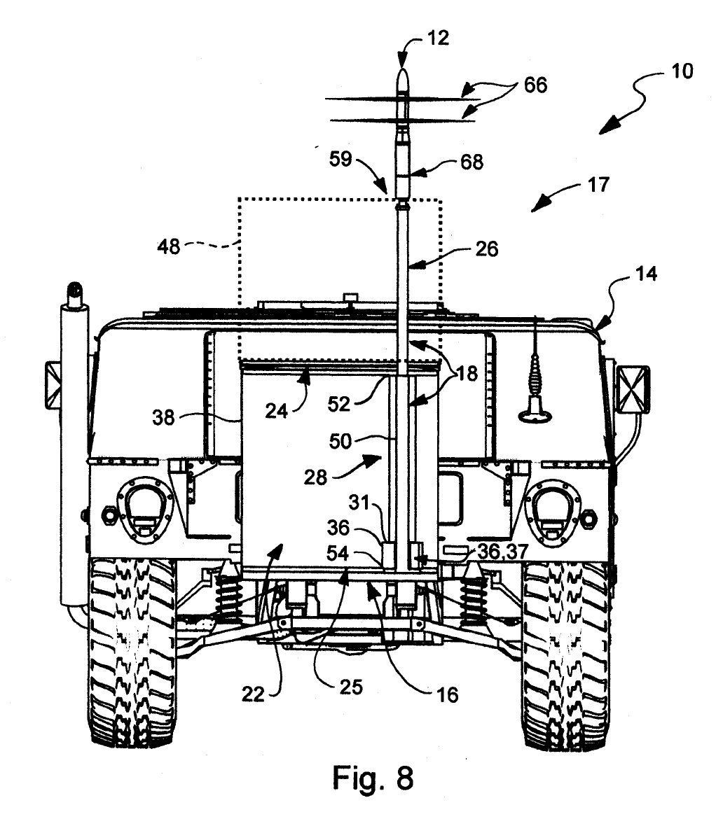

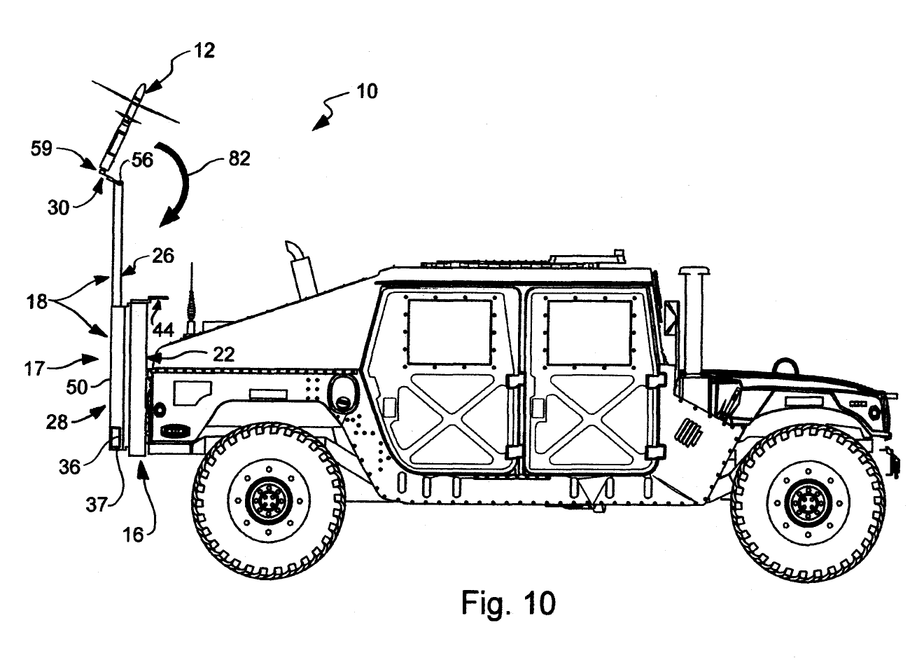

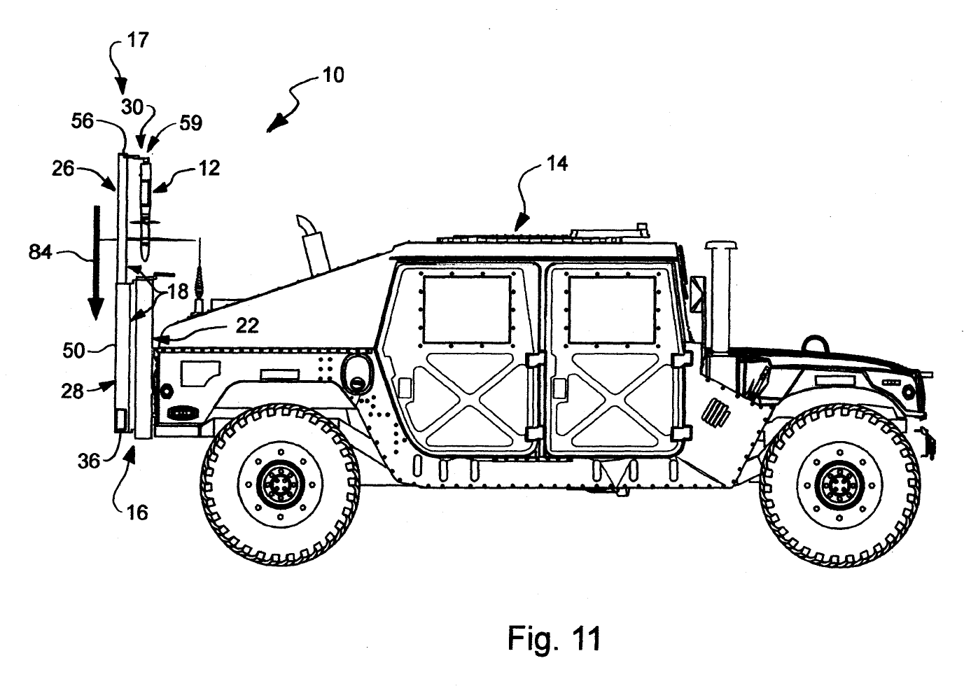

As UAV 12 approaches system 10 in a direction 78, as suggested in FIG. 7, a two-dimensional recovery window 48 is established by computer 34 corresponding to travel limits of multi-axis robotic arm 18, as shown in FIG. 8. UAV 12 is directed by controller 20 through computer 34 to maneuver such that ball stud 62 is located within recovery window 48 as UAV 12 flies toward and passes over vehicle 14. As UAV 12 approaches recovery window 48, controller 20 causes multi-axis robotic arm 18 and latch collet 60 to match the expected two-dimensional position of ball stud 62 within recovery window 48. At a selected instant when ball stud 62 is passing through recovery window 48, latch collet 60 engages ball stud 62 to capture UAV 12. Upon capture of UAV 12, controller 20 is configured to move and position multi-axis robotic arm 18 to return UAV 12 to magazine 22 in directions 82 and 84, as suggested in FIGS. 10 and 11.

In an illustrative embodiment, UAV 12 uses a miniature laser radar (LADAR) or acoustic rangefinder in conjunction with a standard Electro-Optical/Infra-Red (EO/IR) video camera (not shown) or a low-light EO video camera (not shown) to assist in the launching and recovery operations. The LADAR or acoustic rangefinder is bore-sighted to the EO camera to provide an accurate range and closing velocity of UAV 12 to latch collet 60 via computer 34. A camera image is used to track light emitting diode (LED) 64 below ball stud 62 and guide UAV 12 into recovery window 48.

In another illustrative embodiment, a plurality of spaced apart LEDs (not shown) are provided on multi-axis robotic arm 18 to help determine closing range and velocity.

High-speed bi-directional communications 35 between UAV 12 and controller 20, via computer 34, coordinate launching and recovery operations. Absolute orientation vectors, global positioning system (GPS) coordinates, velocity vectors, acceleration vectors of vehicle 14 and UAV 12 and other data are communicated between computer 34 and UAV 12 to calculate a rough terminal flight path for UAV 12 to place ball stud 62 within recovery window 48 of system 10 as ball stud 62 passes into and through recovery window 48.

As the relative distance between vehicle 14 and UAV 12 decreases, for example, to about 20 feet, a more exact positioning system takes control of the recovery operation. A timed acoustic or similar signal emitted by computer 34 is received by UAV 12 and is used to determine a relative separation distance of UAV 12 and system 10. Since UAV 12 has inertia from rotor system 66, UAV 12 is unable to maneuver as quickly as multi-axis robotic arm 18 can move latch collet 60. Thus, a delta coordinate, that is, the difference between the two positions and speeds, is calculated by computer 34 to move multi-axis robotic arm 18 rapidly to position gripper 59, including latch collet 60, in a direction 80 directly in front of a flight path of UAV 12, including the capture device configured as ball stud 62, as suggested in FIGS. 7-9 and 12.

Since steering UAV 12 in flight requires constantly changing an absolute angular orientation of a fuselage 68 of UAV 12, ball stud 62 may approach latch collet 60 at any angle. As UAV 12 approaches latch collet 60, the angular orientation of UAV 12 and vehicle 14 are compared and roll-axis servo 58 and pitch axis servo 36 cooperate to coaxially align latch collet 60 with ball stud 62, as shown best in FIG. 12. The speed of vehicle 14 is calculated by computer 34 and/or UAV 12 within, for example, about +/−5 MPH, and matched to the position and speed of UAV 12 to reduce a shock load on UAV 12 and multi-axis robotic arm 18 when latch collet 60 captures ball stud 62. In an embodiment according to the current disclosure, an additional multi-axis robotic arm or shock absorber (not shown) may be added to multi-axis robotic arm 18 to reduce shock loads on both UAV 12 and multi-axis robotic arm 18, particularly during recovery operations. After recovery, UAV 12 powers down and multi-axis recovery arm 18 transports and maneuvers UAV 12 to magazine 22 for storage therein.

Magazine 22 includes a housing 38 having an upper surface 40, storage tubes 42, and a cover 44. Magazine 22 is arranged to transport and store UAVs 12 before launching and after recovery operations as shown, for example, in FIG. 2. Housing 38 is generally rectangular in shape and includes an interior region 46. Storage tubes 42 are arranged to lie in a spaced-apart side-by-side relationship to one another within interior region 46. Computer 34 and servos 36 may, for example, be positioned under storage tubes 40 within interior region 46, as shown in FIG. 2.

In an illustrative embodiment, housing 38 is formed to include eight storage tubes 42. It is within the scope of this disclosure, however, to include more than eight or less than eight storage tubes 42 therein. Upper surface 40 is formed to include apertures 70 opening into storage tubes 42, as shown in FIG. 3. Apertures 70 are arranged to allow access to UAVs 12 stored in storage tubes 42. While storage tubes 42 are shown orientated vertically with apertures 70 opening upward, it is within the scope of this disclosure to orient storage tubes 42 at any angle, including horizontally, with apertures 70 opening toward the horizon (not shown).

Cover 44 is pivotably coupled to magazine 22 and is actuated by computer 34 to move between a closed position, shown in FIG. 2, where cover 44 closes apertures 70 and storage tubes 42, and an opened position, as shown in FIG. 3, where cover 44 reveals apertures 70, upper surface 40 and storage tubes 42 to allow multi-axis robotic arm 18 to extract or insert one of the UAVs 12 from and to a desired storage tube 42. Cover 44 is configured to protect UAVs 12 stored within magazine 22. Magazine 22 may also be configured to include a power supply 88 for recharging a battery located on board UAV 12 if UAV 12 is electric powered. In an embodiment according to the present disclosure, magazine 22 may be coupled to UAV 12 by way of an inductive coupling (not shown) and alternating current (AC) to transmit electrical power to the battery on board UAV 12 without the need for a physical connection.

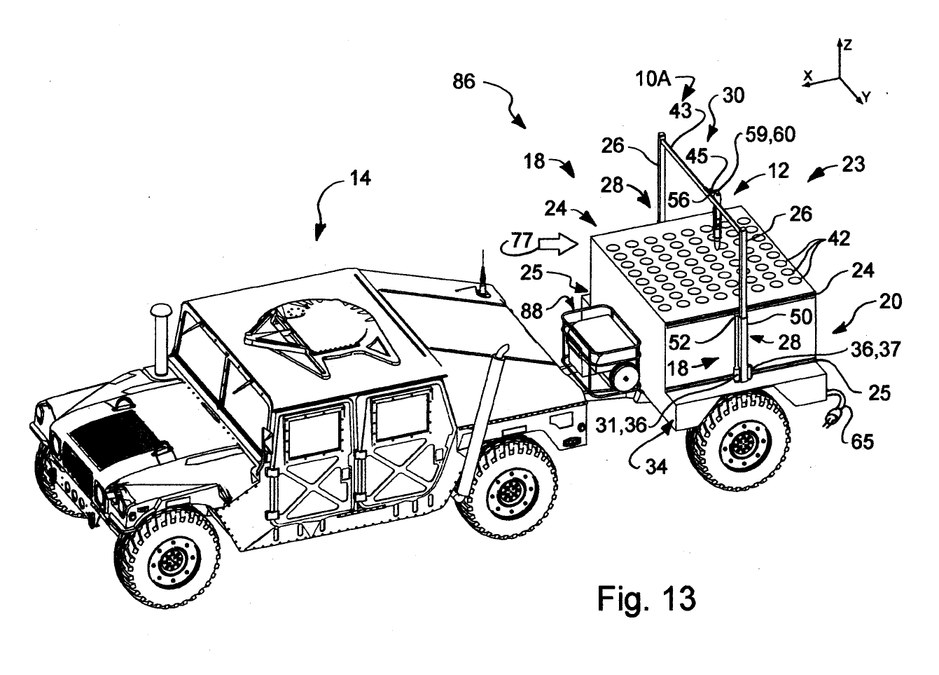

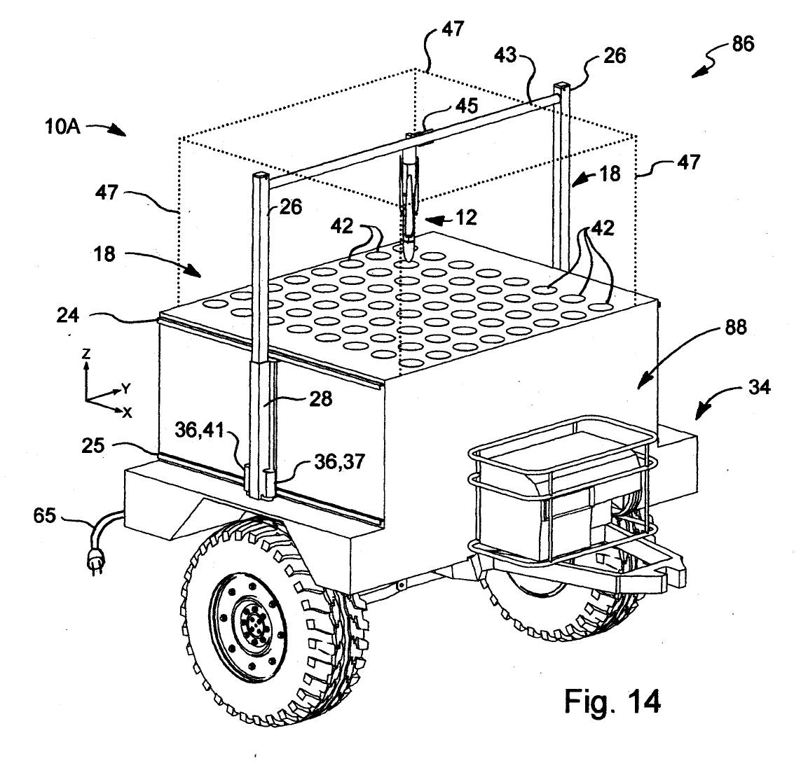

In another illustrative embodiment, as shown in FIGS. 13 and 14, system 10A comprises an magazine 23 including a rectangular array of storage tubes 42 arranged in rows and columns and coupled to a wheeled trailer to form a Mobile Base Unit (MBU) 86. Two multi-axis robotic arms 18 are provided on opposites sides of array magazine 23 to support a cross bar 43 and a servo 41 configured to drive a carriage 45 along cross bar 43. System 10A further comprises multi-axis wrist 30 coupled to carriage 45 which supports a gripper 59 having latch collect 60 which is configured to be positioned by controller 20, including computer 34, configured to manipulate carriage 45 to have access any storage tube 42 in array magazine 23.

A 3-dimensional recovery box 47 is defined by travel limits of the X, Y and Z axes of system 10A as shown by the XYZ triad 49 in FIGS. 13 and 14. One advantage, for example, of the embodiment shown in FIGS. 13 and 14 is that the 3-dimensional recovery box 47 provides a large 3-dimensional volume in which multi-axis wrist 30 is configured to capture ball stud 62 of one of the UAVs 12 which may simplify recovery operations.

In some operational situations it is desirable to repeatedly launch and recover a plurality of UAVs 12 within a short period of time. One such situation occurs in “swarming” operations, wherein a plurality of UAVs 12 are deployed simultaneously and operated in a coordinated fashion to accomplish a common objective or perform complementary functions. Examples of swarming include deploying a line of UAVs 12 spaced apart by several miles to act, for example, as radio communications relays or employing a plurality of UAVs 12 equipped with video cameras. This may be done to visually monitor a crowd of militant demonstrators from several aerial vantage points simultaneously or for coordinating the flight patterns of multiple UAVs 12 over a defined area in search and rescue operations.

In situations requiring fast charging of the batteries on board electric-powered UAVs 12, such as in swarming operations where many UAVs 12 must remain in the air continuously, provisions may be made for a high-power electric generator, shown, for example, as generator 88. Generator size may be an important factor for best operation of the charging system needed for UAVs 12, according to the present disclosure. For example, a UAV 12 may have a 12 volt 10 amp-hour flight battery on board that may need to be charged in 15 minutes. This would require about 40 amps of electrical current. Charging ten (10) UAVs 12 simultaneously would require about 400 amps of electrical current at 12 volts or about 4800 Watts of power. This would require a generator 88, for example, having about 6.5 mechanical horsepower. Charging the 64 UAVs 12 in MBU 86, for instance, would take more than 45 mechanical horse power from an electric generator. Thus, an auxiliary gasoline-powered electric generator 88 may be provided to recharge batteries on board the UAVs 12, as suggested in FIGS. 13 and 14. In an embodiment according to the present disclosure, the engine of driving vehicle 14 may be adapted to operate an electric generator to recharge UAV flight batteries. In another embodiment, according to the present disclosure, an external power cable 65 is provided to connect to an AC power source from a nearby building (not shown), for instance, to provide electrical power for battery charging.

A duty cycle of one or more of the UAVs 12, according to the present disclosure, is defined as a ratio of total time in flight of a UAV 12 divided by the sum of the total time in flight of the UAV plus the total time to recharge the onboard battery of the UAV 12 by, for example, power supply 88. A system duty cycle, for example, for systems 10, 10A and their respectively UAVs 12, depends in large part on the size of electric generator 88. For example, if an electric-powered UAV 12 includes a total flight time of 60 minutes and 15 minutes is required to recharge its on board battery, a maximum duty cycle of that UAV 12 is 60 minutes divided by (60+15) minutes or 60/75, which equals 0.8 or an 80% duty cycle. To support swarming operations with a UAV duty cycle of about 80%, it may be desirable to provide an auxiliary generator 88 or similar power supply sized to charge all UAVs 12 in the systems 10, 10A simultaneously.

While UAVs 12 shown in the figures are configured to be co-axial rotary-wing UAVs, it is within the scope of the present disclosure to configure the UAVs 12 with fixed wings, fins or any other manner of aerodynamic actuator or propulsion device compatible with the systems 10, 10A disclosed herein.

The systems 10, 1 OA disclosed herein include a number of advantageous features. For example, one advantageous feature is the ability to launch and recover UAVs 12 automatically under computer control without human intervention. This feature can increase safety in military applications since soldiers may remain inside buildings and vehicles where they will not be exposed to enemy weapons fire while UAVs 12 are being launched and recovered automatically. Systems 10, 10A may also be operated from a moving vehicle. This may increase safety for vehicles and crewmembers in military applications since moving vehicles pose a more difficult target for enemy fire than do stationary vehicles.

Another advantageous feature is the reduction in costs because no human operator is required to launch and recover the UAVs 12. For applications such as long-term surveillance and monitoring of perimeter fences, oil pipe lines, ship ports, highway congestion, etc., systems 10, 10A may be located remotely from a central data processing area and may operate remotely and automatically without attention from human operators, thereby saving the cost of the human operator that would otherwise be required.

Yet another advantageous feature is the ability of systems 10, 10A to deploy a large number of UAVs 12 in a short time period and to automatically recover, charge and redeploy those UAVs 12 for extended, multi-UAV operations. This may be a particular advantage in “swarming” operations conducted over extended time frames.

Another advantageous feature is that the launching and recovery of the UAVs 12 occurs at a distance from a moving platform, such as vehicle 14, thereby placing the UAVs 12 outside the turbulent boundary layer or wake of moving vehicle 14. This creates more favorable flying conditions for UAV 12 and increases the chance of success in launching and recovery operations. During recovery operations, recovery window 48 and recovery box 47 create large target areas for UAV 12 in which to place ball stud 62, thereby increasing the chances for successful recovery of UAV 12.

Magazine 22 is shown as having storage tubes 42 which are stationary with respect to magazine 22 and a UAV 12 is shown being extracted and inserted by the robotic assembly 17 from/to a stationary storage tube 42. It is within the scope of the present disclosure that one or more storage tubes 42 may be movable or magazine 22 may be movable to facilitate extraction and insertion of a UAV 12, as opposed to the UAV 12 being manipulated by multi-axis robotic arm 18 to be extracted from or inserted into the magazine 22 or storage tube 42. In an embodiment according to the present disclosure, storage tube 42 may be configured to partially open for insertion of UAV 12 and to close around UAV 12 to induce folding of rotor blades or fins of rotor system 66 on UAV 12 (not shown).

It is within the scope of the present disclosure that, regarding the launching and recovering operations of a UAV 12 described herein, the UAV 12 being recovered by systems 10, 10A need not be the same UAV 12 that was launched by that very system 10, 10A. A UAV 12 launched by some other system from some other location may be captured, stored, charged and launched by systems 10, 10A. This would be advantageous, for instance, in convoy operations where a convoy of moving vehicles equipped with systems 10, 10A, in accordance with the present disclosure, supports a swarm of UAVs 12 in a combat air patrol (CAP) above of a convoy at all times. UAVs 12 may be repeatedly launched from one system 10, 10A, provide air cover for the convoy and be recovered and charged by another system 10, 10A.

1. A system for a launching operation of an unmanned aerial vehicle (UAV) and a recovery operation of an unmanned aerial vehicle, (UAV), the system comprising
a magazine configured to store the UAV and
a robotic assembly configured to interact with the magazine, connect to the UAV, and position the UAV relative to the magazine during at least one of a launching operation and a recovery operation.

2. The system of claim 1, wherein the robotic assembly includes a multi-axis robotic arm and a controller configured to communicate with and control the multi-axis robotic arm, and during the launching operation the multi-axis robotic arm is configured to connect to the UAV positioned in the magazine.

3. The system of claim 1, wherein the robotic assembly includes a multi-axis robotic arm and a controller configured to communicate with and control the multi-axis robotic arm, and during the launching operation the multi-axis robotic arm is configured to position the UAV such that the UAV is oriented toward the relative wind during the launching operation.

4. The system of claim 1, wherein the robotic assembly includes a multi-axis robotic arm and a controller configured to communicate with and control the multi-axis robotic arm, and during the recovery operation the multi-axis robotic arm is configured to capture the UAV.

5. The system of claim 1, wherein the robotic assembly includes a multi-axis robotic arm and a controller configured to communicate with and control the multi-axis robotic arm, and during the recovery operation the multi-axis robotic arm is adapted to position the UAV to be stored in the magazine.

6. The system of claim 1 wherein the magazine includes a plurality of storage tubes, the storage tubes being configured to receive and store a plurality of UAVs.

7. The system of claim 1, further comprising a power supply coupled to the magazine and configured to charge an electric battery onboard the UAV, and wherein the UAV communicates with the power supply via the magazine.

8. The system of claim 6, further comprising a power supply and wherein the plurality of UAVs each include an electric battery onboard, each electric battery is charged by the power supply, and the power supply is configured to charge the plurality of UAVs simultaneously.

9. The system of claim 8, wherein each of the plurality of UAVs includes a duty cycle of about 80%, the duty cycle being defined as a ratio of total time in flight of the UAV divided by a sum of the total time in flight plus a total time to recharge the onboard battery of the UAV by the power supply.

10. The system of claim 8, wherein the power supply is one of a gas-powered generator and an AC power source.

11. The system of claim 1, wherein the robotic assembly includes an extension rod and a multi-axis wrist coupled to an end of the extension rod and the UAV includes a capture device thereon, and the multi-axis wrist is configured to be coupled to the capture device on the UAV during at least one of the launching operation and recovery operation.

12. The system of claim 11, wherein the multi-axis wrist includes a gripper and the capture device includes a ball stud and the gripper and the ball stud are configured to cooperate to couple the UAV to the robotic assembly during at least one of the launching operation and the recovery operation.

13. The system of claim 11, wherein the multi-axis wrist includes a pitch connector coupled to the end of the extension rod for pivotable movement relative thereto and provides means for adjusting a pitch attitude of the multi-axis wrist during at least one of the launching operation and the recovery operation.

14. The system of claim 13, wherein the multi-axis wrist includes a roll connector coupled to the pivotable connector and the roll connector is configured to provide means for adjusting a roll altitude of the multi-axis wrist during at least one of the launching operation and the recovery operation.

15. The system of claim 1, wherein the robotic assembly includes a multi-axis robotic arm and a controller in communication with the multi-axis robotic arm and the controller includes a computer and a servo and is configured to position the multi-axis robotic arm during at least one of the launching and the recovery operations.

16. The system of claim 1, wherein the controller includes a computer.

17. A method for launching an unmanned aerial vehicle (UAV), the method steps comprising
providing a storage magazine configured to store the UAV,
providing a multi-axis robotic assembly adjacent to the storage magazine,
separating a UAV from the storage magazine using the multi-axis robotic assembly,
positioning the UAV into a launch position using the robotic assembly,
initiating a UAV launch operation sequence, and
releasing the UAV from the robotic assembly to launch the UAV.

18. A method for recovering an unmanned aerial vehicle (UAV), the method step comprising
providing a robotic assembly including a gripper configured to capture the UAV in flight,
causing the UAV to fly through a two-dimensional recovery window defined by travel limits of the robotic assembly,
matching a two-dimensional position of a capture device on the UAV with a two-dimensional position of the gripper as the UAV passes through the two-dimensional recovery window, and
manipulating the robotic assembly using a computer and coupling the gripper to the UAV as the UAV passes through the two-dimensional recovery window to recover the UAV.

19. The recovery method of claim 18, further comprising the method steps of
providing a storage magazine adjacent the robotic assembly, the storage magazine being configured to store the UAV,
manipulating the robotic assembly such that the UAV is positioned to be stored in the magazine, and
storing the UAV into the storage magazine.

20. The recovery method of claim 19, further comprising the method step of
recharging an electric battery located onboard the UAV while the UAV is in the storage magazine.
